(19) United States
(12) Patent Application Publication
(10) Pub. No.: US 2015/0184047 A1
(43) Pub. Date: Jul. 2, 2015

(54) METHOD FOR MODIFYING SUBSTRATE SURFACE, MODIFYING FILM AND COATING SOLUTION USED FOR MODIFICATION OF SUBSTRATE SURFACE

(71) Applicant: Tokyo Ohka Kogyo Co., Ltd., Kawasaki-shi (JP)

(72) Inventors: Mai Sugawara, Kawasaki-shi (JP); Akira Kumazawa, Kawasaki-shi (JP); Shigeru Yokoi, Kawasaki-shi (JP)

(21) Appl. No.: 14/423,651

(22) PCT Filed: Aug. 27, 2013
(86) PCT No.: PCT/JP2013/072923

§ 371 Date: Feb. 24, 2015

(30) Foreign Application Priority Data
Aug. 30, 2012 (JP) 2012-190291
Aug. 9, 2013 (JP) 2013-166771

(51) Int. Cl. C09K 3/18; B05D 5/08

(52) U.S. Cl. CPC C09K 3/18; B05D 5/08

(57) ABSTRACT

A method for modifying a substrate surface using a silylating agent that is capable of successfully modifying the substrate surface regardless of the substrate material; a modifying film which successfully adheres to a substrate surface regardless of the material of the substrate and provides a substrate that is surface-modified to a desired extent; and a coating solution which is capable of forming a coating film on a substrate surface. A silane compound layer is formed on the surface of the coating film by a silylating agent and is firmly affixed thereto. The surface of a substrate is treated with a metal compound that is capable of producing a hydroxyl group by hydrolysis. The substrate surface which has been treated with the metal compound is then treated with a silylating agent.

### TECHNICAL FIELD

The present invention relates to a method for modifying a substrate surface, a modifying film, and a coating solution used for modifying a substrate surface.

### BACKGROUND ART

Conventionally, modification of surfaces of various substrates has been carried out using various modifiers in order to modify the properties of substrate surfaces, such as affinity of the substrate surfaces to materials to be contacted with the substrate surfaces. In such modification of substrate surfaces, silylating agents with various chemical structures are used depending upon purposes of modification, because of their easy handling and high modification effects.

As the method for modifying a surface of a substrate using a silylating agent, a method for treating a substrate surface using an organosilane having at least one alkylsilyl moiety as the silylating agent has been proposed, in order to improve adhesion of a substrate surface toward a polymer material (Patent Document 1).

Patent Document 1: Japanese Unexamined Patent Application (Translation of PCT Application), Publication No. H11-511900

### DISCLOSURE OF THE INVENTION

### Problems to be Solved by the Invention

However, as disclosed in Patent Document 1, when treating a substrate surface by using substrates such as a tungsten substrate, a titanium nitride substrate, a silicon nitride substrate, a copper substrate and a gold substrate, and a silylating agent, a problem sometime occurs in that a substrate is not modified up to a desired extent as expected. Therefore, there is a need for a method for modifying a substrate surface with a silylating agent which allows modification of a substrate surface regardless of the type of material of the substrate.

The present invention has been made in light of the above-mentioned problems and aims to provide a method for modifying a substrate surface using a silylating agent which is capable of modifying a substrate surface successfully regardless of the material of the substrate. Further, the present invention aims to provide a modifying film which successfully adheres to a substrate surface regardless of the material of the substrate and provides a substrate that is surface-modified to a desired extent. Furthermore, the present invention aims to provide a coating solution which is capable of forming a coating film on a substrate surface, whereby a silane compound layer formed by a silylating agent is able to be successfully firmly affixed to the surface of the coating film.

### Means for Solving the Problems

The present inventors have found that a substrate surface can be modified successfully, regardless of the material of the substrate by treating a substrate surface with a metal compound which is capable of forming a hydroxyl group by hydrolysis, and then treating the surface of the substrate which has been treated with the metal compound, with a silylating agent and have reached the completion of the present invention.

The first aspect of the present invention is a method for modifying a substrate surface comprising:

a process of treating a surface of a substrate with a metal compound which is capable of forming a hydroxyl group by hydrolysis and

a process of treating the surface of the substrate which has been treated with the metal compound, with a silylating agent.

The second aspect of the present invention is:

a modifying film comprising a metal compound layer formed by applying a metal compound which is capable of forming a hydroxyl group by hydrolysis on the surface of a substrate, and a silane compound layer formed by applying a silylating agent on the surface of the metal compound layer.

The third aspect of the present invention is a coating solution which is used for the treatment of a surface of a substrate in the method for modifying a substrate surface according to the first aspect, wherein the coating solution comprises a metal compound which is capable of forming a hydroxyl group by hydrolysis.

### Effects of the Invention

According to the present invention, it is possible to provide a method for modifying a substrate surface using a silylating agent, which is capable of modifying a substrate surface successfully, regardless of the material of the substrate. Further, according to the present invention, it is possible to provide a modifying film which successfully adheres to a substrate surface regardless of the material of the substrate and provides a substrate that is surface-modified to a desired extent. Furthermore, the present invention can provide a coating solution which is capable of forming a coating film on a substrate surface, whereby a silane compound layer formed by a silylating agent is able to be successfully firmly affixed to the surface of the coating film.

### PREFERRED MODE FOR CARRYING OUT THE INVENTION

### [Method for Modifying a Substrate Surface]

The method for modifying a surface of a substrate according to the first aspect comprises:

a first process wherein a substrate surface is treated with a metal compound that is capable of forming a hydroxyl group by hydrolysis, and

a second process wherein the surface of the substrate which has been treated with the metal compound is treated with a silylating agent. Below, the first and the second processes will be explained in order.

### [First Process]

In the first process, the surface of a substrate is treated with a metal compound which is capable of forming a hydroxyl group by hydrolysis. Below, the substrate, the metal compound used for surface modification of the substrate, and the method for treating the substrate surface will be explained.

### [Substrates]

Material of the substrate is not particularly limited, but is selected from various inorganic substrates and organic substrates. Particularly, according to the method of the first aspect, even the substrates which are difficult to be surface-modified in the conventionally-known methods, such as a tungsten substrate, a titanium nitride substrate, a silicon nitride substrate, a copper substrate, and a gold substrate, can be surface-modified successfully.

### [Metal Compounds]

The metal atom encompassed in the metal compounds which are capable of forming a hydroxyl group by hydrolysis (hereinafter referred to as “a hydroxyl group-forming metal compound”) is not particularly limited, within a range where the objects of the present invention are not adversely affected. Examples of the metals contained in the hydroxyl group-forming metal compounds include titanium, zirconium, aluminum, niobium, silicon, boron, lanthanide, yttrium, barium, cobalt, iron, zirconium and tantalum, etc. Among these metal atoms, titanium and silicon are preferred, and silicon is more preferred.

The number of metal atoms contained in the hydroxyl group-forming metal compounds may be 1 or 2 or more, and 1 is preferred. When the hydroxyl group-forming metal compound contains a plurality of metal atoms, the plurality of metal atoms may be the same or different species.

In the hydroxyl group-forming metal compound, the functional group which is capable of forming a hydroxyl group by hydrolysis (hereinafter referred also to as “a hydrolysable group”) is desirably bonded directly to the metal atom.

The number of hydrolysable groups contained in the hydroxyl group-forming metal compound is preferably 2 or more, more preferably 2 to 4, and particularly preferably 4, per metal atom. When the hydroxyl group-forming metal compound has 2 or more hydrolysable groups, the hydroxyl groups generated by hydrolysis causes condensation reaction, whereby a strong coating film composed of a condensate between the hydroxyl group-forming metal compounds is likely to be formed.

Examples of the preferred hydrolysable groups include alkoxy groups, isocyanate groups, and halogen atoms, etc. As the alkoxy group, an aliphatic alkoxy group, such as a linear or branched aliphatic alkoxy group having 1 to 5 carbon atoms, is preferred. Specific examples of the preferred alkoxy groups include a methoxy group, an ethoxy group, an n-propoxy group, an isopropoxy group, and an n-butoxy group, etc. As the halogen atoms, a chlorine atom, a fluorine atom, a bromine atom, and an iodine atom are preferred and a chlorine atom is more preferred.

Among the hydrolysable groups, an isocyanate group and halogen atoms are preferred, and an isocyanate group is more preferred, because of being easily hydrolyzed to form a film on the substrate surface by the reaction between the hydroxyl group-forming metal compounds themselves.

In the hydroxyl group-forming metal compound, a hydrogen atom or an organic group may be bonded to the metal atom together with the hydrolysable group. As the organic group, a linear or branched alkyl group having 1 to 5 carbon atoms is preferred. Specific examples of the alkyl groups having 1 to 5 carbon atoms include a methyl group, an ethyl group, an n-propyl group, an isopropyl group, an n-butyl group, a-sec-butyl group, a tert-butyl group, an n-pentyl group, an isopentyl group, a sec-pentyl group, and a tert-pentyl group.

Metal carbonyl, which is a metal complex having carbon monoxide as a ligand, is also mentioned as a hydroxyl group-forming metal compound. Examples of the metal carbonyl include iron pentacarbonyl (Fe(CO)₅) or a multiple nuclei cluster thereof.

Below, preferred examples of the hydroxyl group-forming metal compound will be explained. Preferred examples of the hydroxyl group-forming metal compound include the compound represented by the following general formula (1):

Rₘ₋ₙMXₙ (1)

wherein M is a metal atom selected from the group consisting of titanium, zirconium, aluminum, niobium, silicon, boron, lanthanide, yttrium, barium, cobalt, iron, zirconium, and tantalum. R is a linear or branched alkyl group having 1 to 5 carbon atoms. X is a group selected from the group consisting of linear or branched alkoxy groups having 1 to 5 carbon atoms, isocyanate groups, and halogen atoms.

m is the number of valences of metal atom M.
n is an integer of 2 or more and m or less.

In general formula (1), specific examples of the hydroxyl group-forming metal compound when X is a linear or branched alkoxy group having 1 to 5 carbon atoms include: a metal alkoxide such as titanium tetra-n-butoxide, zirconium tetra-n-propoxide, aluminum tri-n-butoxide, niobium penta-n-butoxide, tetramethoxy silane, methyl trimethoxy silane, dimethyl dimethoxysilane, ethyl trimethoxy silane, diethyl dimethoxy silane, methyltriethoxysilane, dimethyldiethoxysilane, ethyltriethoxysilane, diethyldiethoxysilane and boron triethoxide, etc.; and a metal alkoxide of rare earth metals such as lanthanoide triisopropoxide and yttrium triisopropoxide.

The condensate of hydrolysate of the hydroxyl group-forming metal compound having two or more alkoxy groups explained above also can be used as the hydroxyl group-forming metal compound, if applicable to a substrate surface.

Examples of the hydroxyl group-forming metal compound wherein X in general formula (1) is an isocyanate group include tetraisocyanate silane, titanium tetraisocyanate, zirconium tetraisocyanate, and aluminum triisocyanate.

When X in general formula (1) is a halogen atom, a chlorine atom, a fluorine atom, a bromine atom and an iodine atom are preferred as X and a chlorine atom is more preferred. Specific examples of the hydroxyl group-forming metal compounds of general formula (1) wherein X is a halogen atom include titanium tetrachloride, tetrachlorosilane, methyl trichlorosilane, dimethyldichlorosilane, ethyltrichlorosilane, diethyldichlorosilane and cobalt (II) chloride, etc.

Among these, the silicon compounds represented by the following general formula (2) are preferred, since these compounds are particularly highly active toward hydrolysis and are capable of easily forming a coating film composed of condensate of the hydroxyl group-forming metal compounds on the substrate surface even without heat treatment.

R₄₋ₙSiXₙ (2)

In formula (2), R is a linear or branched alkyl group having 1 to 5 carbon atoms. X is a group selected from the group consisting of an isocyanate group and halogen atoms. n is an integer of from 2 to 4. In general formula (2), X is preferably an isocyanate group and n is preferably 4.

The metal compounds explained above may be used either alone or in combinations of two or more compounds.

### [Treating Methods]

The methods for treating a surface of a substrate with a hydroxyl group-forming metal compound is not particularly limited, so long as the hydroxyl group-forming metal compound is applicable to the substrate surface in the method and the method is capable of causing hydrolysis of the hydroxyl group-forming metal compound. The hydrolysis of the hydroxyl group-forming metal compound can proceed even by moisture in the air, but after the hydroxyl group-forming metal compound is applied to the substrate surface, water may be sprayed or applied to the substrate surface, in order to accelerate the hydrolysis of the hydroxyl group-forming metal compound, if necessary.

The method for applying the hydroxyl group-forming metal compound to the substrate surface is not particularly limited. As the method for applying the hydroxyl group-forming metal compound to a substrate surface, a method of applying a solution of the hydroxyl group-forming metal compound in an organic solvent to the substrate surface is preferred. The hydroxyl group-forming metal compound may be more likely to be applied evenly to the substrate surface by using the hydroxyl group-forming metal compound in the form of a solution. Further, by using the hydroxyl group-forming metal compound in the form of a solution, it is possible to easily adjust an amount of the hydroxyl group-forming metal compound applied on the substrate surface by controlling the thickness of the formed coating film.

In the treatment of the substrate surface by the hydroxyl group-forming metal compound, it is necessary for the hydrolyzed hydroxyl group-forming metal compounds to react with each other and form a coating film. In the formation of the coating film described above, the substrate surface is preferably made more hydrophilic than in the untreated state. It can be confirmed whether or not the substrate surface is made hydrophilic by, for instance, measuring the degree of hydrophilic property of the substrate surface by means of conventional measures including measuring a contact angle of water before and after the treatment. In the state where the substrate surface is made hydrophilic, hydroxyl groups are present in a large amount, to some extent, on the surface of the coating film formed by the hydroxyl group-forming metal compound, and therefore a silylating agent is more likely to bond to the surface of the coating film formed by the hydroxyl group-forming metal compound in the second process stated below.

As the organic solvent to dissolve the hydroxyl group-forming metal compound, an organic solvent which has no functional group having reactivity toward the hydrolysable group contained in the hydroxyl group-forming metal compound or the hydroxyl group generated by the hydrolysis of the hydroxyl group-forming metal compound (for example, a hydroxyl group) may be used.

Examples of the organic solvent to dissolve the hydroxyl group-forming metal compound include sulfoxides, sulfones, amides, lactams, imidazolidinones, alkylene glycol dialkyl ethers, (poly)alkylene glycol dialkyl ethers, alkylene glycol alkyl ether acetates, (poly)alkylene glycol alkyl ether acetates, ethers, ketones, esters, lactones, linear, branched, or cyclic aliphatic hydrocarbons, aromatic hydrocarbons, and terpenes. Preferred specific examples of the organic solvents to dissolve the hydroxyl group-forming metal compound include chain-like aliphatic hydrocarbons such as decane and decene, alicyclic hydrocarbons such as p-menthane, and aromatic hydrocarbons such as p-cymene. These organic solvents may be used either alone or in combinations of two or more.

Among these, linear, branched or cyclic hydrocarbons are preferred, because these are very hydrophobic and are more likely to suppress the reaction between the hydrolysable group in the hydroxyl group-forming metal compound and moisture in the air in the storing stage of the organic solvent solution of the hydroxyl group-forming metal compound.

In the case where an organic solvent solution of a hydroxyl group-forming metal compound is applied to a substrate surface, the concentration of the hydroxyl group-forming metal compound in the organic solvent solution is not particularly limited, so long as the solution is capable of forming a coating film of the organic solvent solution in a desired thickness on a substrate surface. The concentration of the hydroxyl group-forming metal compound in an organic solvent solution is typically from 0.01 to 50% by mass, and more preferably from 0.3 to 10% by mass.

The method for applying the organic solvent solution of the hydroxyl group-forming metal compound to the substrate surface is not particularly limited, and conventional methods can be applied. Examples of the preferred application method include spraying method, spin coating method, dip coating method, and roll coating method, etc.

Incidentally, for instance in a tungsten substrate or a copper substrate where a natural oxide film is formed on their surfaces, the natural oxide film on the substrate surface may be removed before the treatment with the hydroxyl group-forming metal compound.

The substrate whose surface has been treated with the hydroxyl group-forming metal compound using the methods as explained above may be subjected to a second process explained below either in the state where the substrate surface is dried by an already-known drying process after the treatment or in the state where the substrate surface is wet without being dried. The formation of film by the hydroxyl group-forming metal compound on the substrate surface can proceed sufficiently even only by moisture in the air, but if the substrate surface is made wet with water, the formation of the film proceeds more securely. Therefore, in the case where the substrate surface is wet with water after the treatment with the hydroxyl group-forming metal compound, it is possible to make the formation of film by the hydroxyl group-forming metal compound on the substrate surface more secure by subjecting the substrate to the second process while the substrate is wet.

### [Second Process]

In the silylation process, the surface of the substrate which has been treated with a metal compound which is capable of forming a hydroxyl group by way of hydrolysis is further treated with a silylating agent. Below, modification of a substrate surface, a silylating agent, and a method for treating a substrate surface with the silylating agent are explained.

### [Modification of Substrate Surface]

In the second process, a substrate surface is modified by treatment with a silylating agent. The properties of the substrate surface to be modified are not particularly limited, and are determined depending upon the type of silylating agent used in the treatment.

Specific examples of the modification on the surface of the substrate include the adjustment of affinity to water on the surface of the substrate, for example, water repellency and hydrophilization, the impartment of electrostatic properties to the surface of the substrate by treatment using a positive charged silylating agent including a quaternary ammonium group and a negative charged silylating agent including a carboxyl group or sulfo group, the impartment of reactivity to various chemicals to the surface of the substrate by treatment using a silylating agent having a highly-reactive functional group such as a carboxyl group, an amino group, a hydroxyl group, or a mercapto group, and the like.

Among the modification on the surface of the substrate, water repellency is more preferable. This is because when the surface having a fine pattern thereon is made water repellent, pattern collapse is inhibited.

In recent years, trends in higher integration and miniaturization of semiconductor devices have grown, and thus progress towards miniaturization and higher aspect ratios of the pattern. However, a problem has arisen of so-called pattern collapse in the meantime. This pattern collapse is a phenomenon when forming several patterns on a substrate in parallel, in which adjacent patterns close in so as to lean on one another, and depending on the situation, the pattern become damaged and separate from the base. If such pattern collapse occurs, the desired product will not be obtained, thereby causing a decline in the yield and reliability of the product.

“Pattern” in this context includes both of “a resist pattern”, which is formed on a substrate in a lithography process (exposure/development process), corresponding to a manufacturing process of a semiconductor; and “an inorganic pattern” which is formed in the etching process of a substrate after the lithography process. In these patterns, the modification method of a substrate surface according to the present invention is more effective in the treatment of “an inorganic pattern”.

This pattern collapse is known to occur when drying a rinse liquid in a rinse process with the rinse liquid such as pure water, due to the surface tension of this rinse liquid. In fact, when the rinse liquid is removed in a drying step, stress based on the surface tension of the rinse liquid acts between patterns, whereby pattern collapse occurs.

Herein, the force F acting between the patterns during drying after rinse is represented as in the following formula (I). In the formula, γ represents the surface tension of the rinse liquid, θ presents the contact angle of the rinse liquid, A represents the aspect ratio of the pattern, and D represents the distance between the pattern side walls.

F=2γ·cos θ·A/D (I)

Therefore, if the surface of the pattern can hydrophobized and the contact angle of the rinse liquid increased (cos θ reduced), the force acting between the patterns during the drying after rinse can be reduced, and thus pattern collapse can be prevented.

In addition, as the aspect ratio of the pattern becomes high, the force F that is created between the patterns becomes high, and thus, there is a tendency that the effect of the water repellency on inhibiting the breaking of the pattern is increased.

### [Silylating Agent]

The type of silylating agent is not particularly limited as long as it can modify the property of the surface of the substrate to be the desired property, and it is properly selected from the silylating agents that are conventionally used for the modification of various materials, and then, used. Below, the silylating agent that is used for providing a substrate surface with water repellency, that is, the preferred modification among the above-described modifications, will be described.

The silylating agent that is used for the provision of the water repellency to the substrate surface is not particularly limited as long as it can obtain the water repellency effect that is desired on the surface of the substrate, and it may be properly selected from the silylating agents that are conventionally used as a water repelling agent for various materials, and then used. Examples of the preferred silylating agent include the silylating agent represented by general formulas (3) to (10) below, or cyclic silazane compounds. Below, the silylating agent represented by general formulas (3) to (10) below and the cyclic silazane compounds will be described in order.

### (Silylating Agent Represented by General Formula (3))

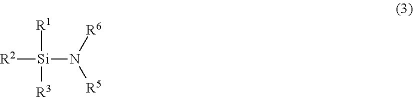

In general formula (3), R¹, R², and R³ each independently represents a hydrogen atom, a halogen atom or an organic group. The total of the number of carbon atoms of R¹, R², and R³ is 1 or more. R⁴ represents a hydrogen atom or a saturated or unsaturated chain-like hydrocarbon group. R⁵ represents a hydrogen atom, a saturated or unsaturated chain-like hydrocarbon group, a saturated or unsaturated non-aromatic cyclic hydrocarbon group, or a non-aromatic heterocyclic group. R⁴ and R⁵ may be bonded to each other to form a non-aromatic heterocyclic group including a nitrogen atom.

When R¹, R², and R³ are halogen atoms, a chlorine atom, a bromine atom, an iodine atom, and a fluorine atom are preferred.

When R¹, R², and R³ are organic groups, the organic groups may include a hetero atom besides the carbon atoms. Types of the hetero atoms which the organic groups may include are not particularly limited, within a range where objects of the present invention are not adversely affected. As the hetero atoms which the organic groups may include, N, O, and S are preferred. When R¹, R², and R³ are organic groups, the total of the number of carbon atoms and the number of hetero atoms included in the organic groups is not particularly limited, so far as the total of the number of carbon atoms of R¹, R², and R³ is 1 or more. When R¹, R², and R³ are organic groups, the total of the number of carbon atoms and the number of hetero atoms included in the organic groups is preferably from 1 to 10, more preferably from 1 to 8, and particularly preferably from 1 to 3. When R¹, R², and R³ are organic groups, as the organic groups, a saturated or unsaturated chain-like hydrocarbon group, an aralkyl group and an aromatic hydrocarbon group are preferred. Preferred examples of the saturated or unsaturated chain-like hydrocarbon groups include a methyl group, an ethyl group, a vinyl group, an n-propyl group, an isopropyl group, an allyl group, a 1-propenyl group, an isopropenyl group, an n-butyl group, a sec-butyl group, a tert-butyl group, a 3-butenyl group, an n-pentyl group, an isopentyl group, a sec-pentyl group, a tert-pentyl group, an n-hexyl group, an n-heptyl group, an n-octyl group, an n-nonyl group and an n-decyl group, etc. Among these chain-like hydrocarbon groups, a methyl group, an ethyl group, a vinyl group, an n-propyl group, and an allyl group are more preferred and a methyl group, an ethyl group and a vinyl group are particularly preferred. Preferred examples of the aralkyl groups include a benzyl group, a phenylethyl group, a phenylpropyl group, α-naphthylmethyl group and β-naphthylmethyl group. Preferred examples of the aromatic hydrocarbon groups include a phenyl group, an α-naphthyl group, and a β-naphthyl group.

When R⁴ is a saturated or unsaturated chain-like hydrocarbon group, the number of carbon atoms of the saturated or unsaturated chain-like hydrocarbon group is not particularly limited, within a range where objects of the present invention are not adversely affected. When R⁴ is a saturated or unsaturated chain-like hydrocarbon group, the number of carbon atoms of the saturated or unsaturated chain-like hydrocarbon group is preferably from 1 to 10, more preferably from 1 to 8, and particularly preferably from 1 to 3. Preferred examples of R⁴ when R⁴ is a saturated or unsaturated chain-like hydrocarbon group is the same as the saturated or unsaturated chain-like hydrocarbon groups mentioned as the preferred groups for R¹, R², and R³.

When R⁵ is a saturated or unsaturated chain-like hydrocarbon group, the saturated or unsaturated chain-like hydrocarbon group is the same as R⁴. When R⁵ is a saturated or unsaturated cyclic hydrocarbon group, the number of carbon atoms of the saturated or unsaturated cyclic hydrocarbon group is not particularly limited, within the range where objects of the present invention are not hindered. When R⁵ is a saturated or unsaturated non-aromatic cyclic hydrocarbon group, the number of carbon atoms of the saturated or unsaturated non-aromatic cyclic hydrocarbon group is preferably from 3 to 10, more preferably from 3 to 6, and particularly preferably 5 or 6. Preferred examples of R⁵ when R⁵ is a saturated or cyclic hydrocarbon group include a cyclopropyl group, a cyclobutyl group, a cyclopentyl group, a cyclohexyl group, a cyclopentyl group and a cyclooctyl group. When R⁵ is a non-aromatic heterocyclic group, the hetero atom included in the non-aromatic heterocyclic groups is not particularly limited, within a range where objects of the present invention are not adversely affected. When R⁵ is a non-aromatic heterocyclic group, examples of the preferred hetero atoms included in the non-aromatic heterocyclic groups include N, O, and S. When R⁵ is a non-aromatic heterocyclic group, a total of the number of carbon atoms and the number of hetero atoms included in the non-aromatic heterocyclic group is not particularly limited, within a range where objects of the present invention are not adversely affected. When R⁵ is a non-aromatic heterocyclic group, the total of the number of carbon atoms and the number of hetero atoms included in the non-aromatic heterocyclic group is preferably from 3 to 10, more preferably from 3 to 6, and particularly preferably 5 or 6. Preferred examples of R⁵ when R⁵ is a non-aromatic heterocyclic group include a pyrolidine-1-yl group, a piperidine-1-yl group, a piperadine-1-yl group, a morpholine-1-yl group, and a thiomorpholine-1-yl group.

The number of atoms included in the non-aromatic heterocyclic group formed by R⁴ and R⁵ bonding to each other is not particularly limited within a range where objects of the present invention are not adversely affected. The non-aromatic heterocyclic group formed by R⁴ and R⁵ bonding to each other is preferably a three- to ten-membered ring, and more preferably a five- or six-membered ring. The type of hetero atoms other than the carbon atom included in the non-aromatic heterocyclic group formed by R⁴ and R⁵ bonding to each other is not particularly limited, within a range where objects of the present invention are not adversely affected. Examples of the preferred hetero atoms included in the non-aromatic heterocyclic group formed by R⁴ and R⁵ bonding to each other include N, O, and S. Examples of the preferred non-aromatic heterocyclic ring formed by R⁴ and R⁵ bonding to each other include pyrolidine, piperidine, piperadine, morpholine, and thiomorpholine.

Specific examples of the silylating agent represented by the general formula (3) include N,N-dimethylaminotrimethylsilane, N,N-dimethylaminodimethylsilane, N,N-dimethylaminomonomethylsilane, N,N-diethylaminotrimethylsilane, t-butylaminotrimethylsilane, allylaminotrimethylsilane, trimethylsilylacetamide, N,N-dimethylaminodimethylvinylsilane, N,N-dimethylaminodimethylpropylsilane, N,N-dimethylaminodimethyloctylsilane, N,N-dimethylaminodimethylphenylethylsilane, N,N-dimethylaminodimethylphenylsilane, N,N-dimethylaminodimethyl-t-butylsilane, N,N-dimethylaminotriethylsillane, and trimethylsilanamine, etc.

### (Silylating Agent Represented by General Formula (4))

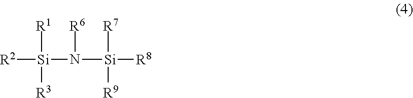

In general formula (4), R¹, R², and R³ are the same as in general formula (3) described above. R⁶ represents a hydrogen atom, a methyl group, a trimethylsilyl group, or a dimethylsilyl group. R⁷, R⁸, and R⁹ each independently represents a hydrogen atom or an organic group. The total of the number of carbon atoms of R⁷, R⁸, and R⁹ is 1 or more.

When R⁷, R⁸, and R⁹ are organic groups, the organic groups are the same as the organic groups in the case where R¹, R², and R³ are organic groups.

Specific examples of the silylating agent represented by the general formula (4) include hexamethyldisilazane, N-methyl-hexamethyldisilazane, 1,1,3,3-tetramethyldisilazane, 1,3-dimethyldisilazane, 1,3-di-n-octyl-1,1,3,3-tetramethyldisilazane, 1,3-divinyl-1,1,3,3-tetramethyldisilazane, tris(dimethylsilyl)amine, tris(trimethylsilyl)amine, 1-ethyl-1,1,3,3,3-pentamethyldisilazane, 1-vinyl-1,1,3,3,3-pentamethyldisilazane, 1-propyl-1,1,3,3,3-pentamethyldisilazane, 1-phenylethyl-1,1,3,3,3-pentamethyldisilazane, 1-tert-butyl-1,1,3,3,3-pentamethyldisilazane, 1-phenyl-1,1,3,3,3-pentamethyldisilazane, and 1,1,1-trimethyl-3,3,3-triethyldisilazane, etc.

### (Silylating Agent Represented by General Formula (5))

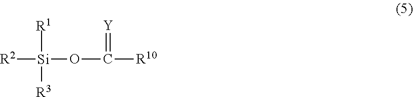

In general formula (5), R¹, R², and R³ are the same as in general formula (3) described above. Y represents 0, CHR¹¹, CHOR¹¹, CR¹¹R¹¹, or NR¹². R¹⁰ and R¹¹ each independently represents a hydrogen atom, a saturated or unsaturated chain-like hydrocarbon group, a saturated or unsaturated non-aromatic cyclic hydrocarbon group, a trialkylsilyl group, a trialkylsiloxy group, an alkoxy group, a phenyl group, a phenylethyl group, or an acetyl group. R¹² represents a hydrogen atom, an alkyl group, or a trialklsilyl group.

When R¹⁰ and R¹¹ are a saturated or unsaturated chain-like hydrocarbon group or a saturated or unsaturated non-aromatic cyclic hydrocarbon group, the saturated or unsaturated chain-like hydrocarbon group and the saturated or unsaturated non-aromatic cyclic hydrocarbon group are the same as in the case where R⁵ in general formula (3) is a saturated or unsaturated chain-like hydrocarbon group or a saturated or unsaturated non-aromatic cyclic hydrocarbon group.

When R¹⁰ and R¹¹ are a trialkylsilyl group, a trialkylsiloxy group or an alkoxy group, the number of carbon atoms of the alkyl groups included in these groups is not particularly limited, within a range where objects of the present invention are not adversely affected. The number of carbon atoms of the alkyl groups included in these groups is preferably from 1 to 10, more preferably from 1 to 8, and particularly preferably from 1 to 3. Preferred examples of the alkyl groups included in these groups include a methyl group, an ethyl group, an n-propyl group, an isopropyl group, an n-butyl group, a sec-butyl group, a tert-butyl group, an n-pentyl group, an isopentyl group, a sec-pentyl group, a tert-pentyl group, an n-hexyl group, an n-heptyl group, an n-octyl group, an n-nonyl group, and an n-decyl group, etc. Among these alkyl groups, a methyl group, an ethyl group, and an n-propyl group are more preferred, and a methyl group and an ethyl group are particularly preferred.

When R¹² is an alkyl group or a trialkylsilyl group, the number of carbon atoms included in the alkyl group or the trialkylsilyl group is not particularly limited, within a range where objects of the present invention are not adversely affected. The number of carbon atoms included in the alkyl group or the trialkylsilyl group is preferably from 1 to 10, more preferably from 1 to 8, and particularly preferably from 1 to 3. Preferred examples of the alkyl groups included in the alkyl group or the trialkylsilyl group include a methyl group, an ethyl group, an n-propyl group, an isopropyl group, an n-butyl group, a sec-butyl group, a tert-butyl group, an n-pentyl group, an isopentyl group, a sec-pentyl group, a tert-pentyl group, an n-hexyl group, an n-heptyl group, an n-octyl group, an n-nonyl group, and an n-decyl group, etc. Among these, a methyl group, an ethyl group, and an n-propyl group are more preferred, and a methyl group and an ethyl group are particularly preferred.

Specific examples of the silylating agent represented by the general formula (5) include trimethylsilylacetate, dimethylsilylacetate, monomethylsilyacetate, trimethylsilylpropionate, trimethylsilybutylate and trimethylsilyl-2-butenoate, etc.

### (Silylating Agent Represented by General Formula (6))

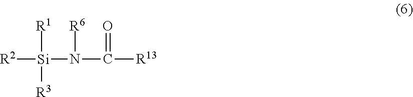

In general formula (6), R¹, R², and R³ are the same as in general formula (3) described above. R⁶ is the same as in general formula (4) described above. R¹³ represents a hydrogen atom, a saturated or unsaturated chain-like hydrocarbon group, a trifluoromethyl group, or a trialkylsilylamino group.

When R¹³ represents a saturated or unsaturated chain-like hydrocarbon group, the saturated or unsaturated chain-like hydrocarbon group is the same as in the case where R⁴ in general formula (3) is a saturated or unsaturated chain-like hydrocarbon group.

When R¹³ is a trialkylsilylamino group, the alkyl groups included therein are the same as the alkyl groups included in the trialkylsilyl group, the trialkylsiloxy group, or the alkoxy group in the case where R¹⁰ and R¹¹ in general formula (5) are these groups.

Specific examples of the silylating agent represented by the general formula (6) include N,N-bis(trimethylsilyl)urea, N-trimethylsilylacetamide, N-methyl-N-trimethylsilyltrifluoroacetamide and N,N-bis(trimethylsilyl)trifluoroacetamide, etc.

### (Silylating Agent Represented by General Formula (7))

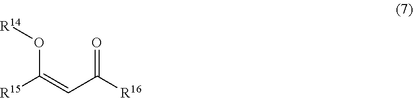

In general formula (7), R¹⁴ represents a trialkylsilyl group. R¹⁰ and R¹⁶ each independently represents a hydrogen atom or an organic group.

When R¹⁴ is a trialkylsilyl group, the alkyl groups included therein are the same as the alkyl groups included in the trialkylsilyl group, the trialkylsiloxy group, or the alkoxy group in the case where R¹⁰ and R¹¹ in general formula (5) are these groups.

When R¹⁵ and R¹⁶ are an organic group, the organic group is the same as the organic group in the case where R¹, R² and R³ in general formula (3) are organic groups.

Specific examples of the silylating agent represented by the general formula (7) include 2-trimethylsiloxypenta-2-en-4-on, etc.

### (Silylating Agent Represented by General Formula (8))

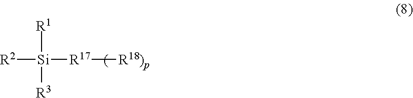

In general formula (8), R¹, R² and R³ are the same as in general formula (3) described above. R¹⁷ represents a saturated or unsaturated chain-like hydrocarbon group, a saturated or unsaturated non-aromatic cyclic hydrocarbon group, or a non-aromatic heterocyclic group. R¹⁸ represents —SiR¹R²R³. p is 0 or 1.

When p is 0, the saturated or unsaturated chain-like hydrocarbon group, the saturated or unsaturated non-aromatic cyclic hydrocarbon group, or the non-aromatic heterocyclic group as R¹⁷ is the same as R⁵ in general formula (3). When p is 1, the organic group as R¹⁷ is a divalent group obtained by removing a hydrogen atom from the organic group in the case where R¹, R² and R³ in general formula (3) are organic groups.

Specific examples of the silylating agent represented by the general formula (8) include 1,2-bis(dimethylchlorosilyl)ethane and t-butyldimethylchlorosilane, etc.

### (Silylating Agent Represented by General Formula (9))

R¹⁹_{q}Si[N(CH₃)₂]_{4-q} (9)

In general formula (9), R¹⁹ each is independently a chain-like hydrocarbon group having 1 to 18 carbon atoms, wherein a part or all of the hydrogen atoms may be replaced with a fluorine atom or fluorine atoms. q is 1 or 2.

In general formula (9), the number of carbon atoms of R¹⁹ is preferably from 2 to 18, and more preferably from 8 to 18.

Examples of R¹⁹ which is a chain-like saturated hydrocarbon group not substituted with a fluorine atom include a methyl group, an ethyl group, an n-propyl group, an isopropyl group, a butyl group, a sec-butyl group, a tert-butyl group, an isobutyl group, an amyl group, an isoamyl group, a tert-amyl group, a-hexyl group, a 2-hexyl group, a 3-hexyl group, a heptyl group, a 2-heptyl group, a 3-heptyl group, an isoheptyl group, a tert-heptyl group, an n-octyl group, an isooctyl group, a tert-octyl group, a 2-ethylhexyl group, a nonyl group, an isononyl group, a decyl group, a dodecyl group, a tridecyl group, a tetradecyl group, a pentadecyl group, a hexadecyl group, a heptadecyl group and an octadecyl group, etc.

Examples of R¹⁹ which is a chain-like unsaturated hydrocarbon group not substituted with a fluorine atom include a vinyl group, a 1-propenyl group, an allyl group, an isopropenyl group, a 1-butenyl group, a 2-butenyl group, a 3-butenyl group, a 1,3-butadienyl group, a 1-ethylvinyl group, a 1-methyl-1-propenyl group, a 1-methyl-2-propenyl group, a 4-pentenyl group, a 1,3-pentadienyl group, a 2,4-pentadienyl group, a 3-methyl-1-butenyl group, a 5-hexenyl group, a 2,4-hexadienyl group, a 6-heptenyl group, a 7-octenyl group, a 8-nonenyl group, a 9-decenyl group, a 10-undecenyl group, a 11-dodecenyl group, a 12-tridecenyl group, a 13-tetradecenyl group, a 14-pentadecenyl group, a 15-hexadecenyl group, a 16-heptadecenyl group, a 17-octadecenyl group, an ethynyl group, a propargyl group, a 1-propynyl group, a 1-butynyl group, a 2-butynyl group, a 3-butynyl group, a 1-pentynyl group, a 2-pentynyl group, a 3-pentynyl group, a 4-pentynyl group, a 1-hexynyl group, a 2-hexynyl group, a 3-hexynyl group, a 4-hexynyl group, a 5-hexynyl group, a 6-heptynyl group, a 7-octynyl group, a 8-nonynyl group, a 9-decynyl group, a 10-undecynyl group, a 11-dodecynyl group, a 12-tridecynyl group, a 13-tetradecynyl group, a 14-pentadecynyl group, a 15-hexadecynyl group, a 16-heptadecynyl group and a 17-octadecynyl group, etc.

When R¹⁹ is a chain-like hydrocarbon group substituted with a fluorine atom, the number of substitution and the position of substitution are not particularly limited. The number of substitutions with fluorine atoms in the chain-like hydrocarbon group is preferably 50% or more, more preferably 70% or more, and particularly preferably 80% or more, of the number of hydrogen atoms that the chain-like hydrocarbon group includes.

As R¹⁹, a linear hydrocarbon group having 1 to 18 carbon atoms wherein a part or all of the hydrogen atoms may be substituted with a fluorine atom or fluorine atoms is preferred, since good water repellency is more likely to be obtained. Further, as R¹⁹, a linear saturated hydrocarbon group having 1 to 18 carbon atoms (an alkyl group having 1 to 18 carbon atoms) wherein a part or all of the hydrogen atoms may be substituted with a fluorine atom or fluorine atoms is more preferred, from a standpoint of storage stability of a silylating agent.

In general formula (9), q is 1 or 2, and 1 is preferred.

### (Silylating Agent Represented by General Formula (10))

R²⁰ᵣ[N(CH₃)₂]₃₋ᵣSi—R²²—SiR²¹ₛ[N(CH₃)₂]₃₋ₛ (10)

In general formula (10), R²⁰ and R²¹ each is independently a hydrogen atom or a linear or branched alkyl group having 1 to 4 carbon atoms. R²² is a linear or branched alkylene group having 1 to 16 carbon atoms. r and s each is independently an integer of 0 to 2.

R²⁰ and R²¹ may be the same as or different from each other. As R²⁰ and R²¹, a hydrogen atom or a linear or branched alkyl group having 1 to 3 carbon atoms is preferred, a hydrogen atom or a methyl group is more preferred, and a methyl group is particularly preferred.

Specific examples of R²⁰ and R²¹ which are linear or branched alkyl groups having 1 to 4 carbon atoms include a methyl group, an ethyl group, an n-propyl group, an isopropyl group, an n-butyl group, a sec-butyl group, a tert-butyl group, and an isobutyl group.

The compounds represented by general formula (10) include linear or branched alkylene groups having 1 to 16 carbon atoms as R²². The number of carbon atoms of the linear or branched alkylene group which is R²² is preferably 1 to 10, and more preferably 2 to 8. Incidentally, a linear alkylene group means a methylene group or α, ω-linear alkylene groups and a branched alkylene group means alkylene groups other than the methylene group and the α, ω-linear alkylene groups. R²² is preferably a linear alkylene group.

Examples of R²² which is a linear or branched alkylene group having 1 to 16 carbon atoms include a methylene group, a 1,2-ethylene group, a 1,1-ethylene group, a propane-1,3-diyl group, a propane-1,2-diyl group, a propane-1,1-diyl group, a propane-2,2-diyl group, a butane-1,4-diyl group, a butane-1,3-diyl group, a butane-1,2-diyl group, a butane-1,1-diyl group, a butane-2,2-diyl group, a butane-2,3-diyl group, a pentane-1,5-diyl group, a pentane-1,4-diyl group, a hexane-1,6-diyl group, a heptane-1,7-diyl group, an octane-1,8-diyl group, a 2-ethylhexane-1,6-diyl group, a nonane-1,9-diyl group, a decane-1,10-diyl group, an undecane-1,11-diyl group, a dodecane-1,12-diyl group, a tridecane-1,13-diyl group, a tetradecane-1,14-diyl group, a pentadecane-1,15-diyl group and a hexadecane-1,16-diyl group, etc.

In the compounds represented by general formula (10), s and r each is independently an integer of 0 to 2. In the compounds represented by general formula (10), s and r are preferably 1 or 2, and are more preferably 2, since synthesis and availability thereof is easy.

### (Cyclic Silazane Compounds)

As the silylating agent, cyclic silazanes are also preferred. Below, cyclic silazanes will be explained.

Examples of the cyclic silazane compounds include cyclic disilazane compounds such as 2,2,5,5-tetramethyl-2,5-disila-1-azacyclopentane, 2,2,6,6-tetramethyl-2,6-disila-1-azacyclohexane; cyclic trisilazane compounds such as 2,2,4,4,6,6-hexamethylcyclotrisilazane, 2,4,6-trimethyl 2,4,6-trivinylcyclotrisilazane; and cyclic tetrasilazane compounds such as 2,2,4,4,6,6,8,8-octamethylcyclotetrasilazane.

Among these, cyclic disilazane compounds are preferred and 2,2,5,5-tetramethyl-2,5-disila-1-azacyclopentane and 2,2,6,6-tetramethyl-2,6-disila-1-azacyclohexane are more preferred. Examples of the cyclic disilazane compounds include those having a five-membered structure, such as 2,2,5,5-tetramethyl-2,5-disila-1-azacyclopentane and those having a six-membered structure, such as 2,2,6,6-tetramethyl-2,6-disila-1-azacyclohexane, but a five-membered structure is more preferred.

### [Method for Treating]

As the method for treating a substrate surface with a silylating agent, conventional methods may be used without any particular limitation. For instance, examples of such methods include a method wherein a silylating agent is vaporized to form a vapor and the vapor is brought into contact with a substrate surface; and methods wherein a surface treatment agent containing a silylating agent is brought into contact with a substrate surface by means of spraying method, spin coating method, dip coating method and roll coating method, etc.

Among the methods described above, the method wherein a surface treating agent comprising a silylating agent is brought into contact with a substrate surface, because it is easier to treat the substrate surface evenly, is preferred. The surface treating agent comprising a silylating agent preferably comprises an organic solvent in addition to the silylating agent. As the organic solvent contained in the surface treating agent, organic solvents which are inert to the surface treating agent may be used without any particular limitation.

Specific examples of the surface treating agent comprising a silylating agent include sulfoxides such as dimethylsulfoxide; sulfones such as dimethylsulfone, diethylsulfone, bis(2-hydroxyethyl)sulfone and tetramethylenesulfone; amides such as N,N-dimethylformamide, N-methylformamide, N,N-dimethylacetamide, N-methylacetamide and N,N-diethylacetamide; lactams such as N-methyl-2-pyrrolidone, N-ethyl-2-pyrrolidone, N-propyl-2-pyrrolidone, N-hydroxymethyl-2-pyrrolidone and N-hydroxyethyl-2-pyrrolidone; imidazolidinones such as 1,3-dimethyl-2-imidazolidinone, 1,3-diethyl-2-imidazolidinone and 1,3-diisopropyl-2-imidazolidinone; (poly)alkylene glycol dialkyl ethers such as ethylene glycol dimethyl ether, ethylene glycol diethyl ether, diethylene glycol dimethyl ether, diethylene glycol methyl ether, diethylene glycol diethyl ether, and triethylene glycol dimethyl ether; (poly)alkylene glycol alkyl ether acetates such as ethylene glycol monomethyl ether acetate, ethylene glycol monoethyl ether acetate, diethylene glycol monomethyl ether acetate, diethylene glycol monoethyl ether acetate, propylene glycol monomethyl ether acetate and propylene glycol monoethyl ether acetate; other ethers such as tetrahydrofuran; ketones such as methyl ethyl ketone, cyclohexanone, 2-heptanone and 3-heptanone; alkyl lactats such as methyl 2-hydroxypropanoate and ethyl 2-hydroxypropanoate; other esters such as methyl 3-methoxypropanoate, ethyl 3-methoxypropanoate, methyl 3-ethoxypropanoate, ethyl 3-ethoxypropanoate, ethyl ethoxyacetate, 3-methyl-3-methoxybutyl acetate, 3-methyl-3-methoxybutyl propionate, ethyl acetate, n-propyl acetate, i-propyl acetate, n-butyl acetate, i-butyl acetate, n-pentyl formate, i-pentyl acetate, n-butyl propionate, ethyl butyrate, n-propyl butyrate, i-propyl butyrate, n-butyl butyrate, methyl pyruvate, ethyl pyruvate, n-propyl pyruvate, methyl acetoacetate, ethyl acetoacetate and ethyl 2-oxobutanoate; lactones such as β-propiolactone, γ-butyrolactone and 5-pentyrolactone; linear, branched or cyclic hydrocarbons such as n-hexane, n-heptane, n-octane, n-nonane, methyl octane, n-decane, n-undecane, n-dodecane, 2,2,4,6,6-pentamethyl heptane, 2,2,4,4,6,8,8-heptamethylnonane, cyclohexane, and methyl cyclohexane; aromatic hydrocarbons such as benzene, toluene, naphthalene, and 1,3,5-trimethylbenzene; and terpenes such as p-menthane, diphenyl menthane, limonene, terpinene, bornane, norbornane, and pinane, etc. These organic solvents may be used either alone or in combination of two or more.

After the substrate surface has been treated with a silylating agent, the organic solvent or water remaining on the substrate surface is preferably removed, if necessary. The methods of removing water or an organic solvent are not particularly limited, but include, for example, blowing gas such as nitrogen or dry air over the substrate surface, heating the substrate up to an appropriate temperature, depending on the boiling point of the solvent to be removed.

### [Modifying Film]

The second aspect of the present invention is a modifying film comprising a metal compound layer formed by applying a metal compound that is capable of forming a hydroxyl group by hydrolysis to the surface of a substrate, and a silane compound layer formed by applying a silylating agent to the surface of the metal compound layer. The methods for forming a modifying film are not particularly limited, but the afore-mentioned modifying film is preferably formed by the method for modifying a substrate surface according to the first aspect.

Depending on the material of the substrate, even if a silylating agent is applied to the surface of the substrate, the silane compound layer formed by the silylating agent is sometimes not affixed to the substrate surface sufficiently, so that the substrate surface is not modified to a desired extent. However, since the modifying film according to the second aspect comprises a metal compound layer having a hydroxyl group, the surface of the substrate being covered with the metal compound layer having a hydroxyl group; and a silane compound layer which is formed on the surface of the metal compound layer by reacting the hydroxyl group of the metal compound layer with a silylating agent, the silane compound layer is firmly affixed to the surface of the metal compound layer successfully and accordingly the metal compound layer is firmly affixed to the substrate surface successfully. Therefore, when a substrate is provided with the modifying film according to the second aspect, the properties of the substrate surface can be modified to a desired extent.

As explained concerning the method for modifying the substrate surface according to the first aspect, as the modification of the substrate surface, provision of water-repellency is preferred. Therefore, the modifying film according to the second aspect is preferably a modifying film whose silane compound layer is formed by using a water-repelling agent as the silylating agent.

### [Coating Solution]

The third aspect of the present invention is a coating solution comprising a metal compound which is capable of forming a hydroxyl group by hydrolysis, wherein the coating solution is used for treating the surface of a substrate in the method for modifying a substrate surface according to the first aspect.

As explained concerning the method for modifying a substrate surface according to the first aspect, a solution containing a metal compound capable of forming a hydroxyl group by hydrolysis (a hydroxyl group-forming metal compound) is used as a coating solution; the coating solution is applied to a substrate surface; condensation occurs among the hydroxyl groups formed by the hydrolysis; and thereby a strong coating film composed of a condensate between the hydroxyl group-forming metal compounds can be formed on the substrate surface.

The coating film composed of the condensate of the hydroxyl group-forming metal compounds has hydroxyl groups on the surface. Therefore, if a strong coating film composed of a condensate of hydroxyl group-forming metal compounds is formed on a substrate surface, a silane compound layer formed by a silylating agent can be firmly affixed to the substrate surface successfully via the coating film, which is a metal compound layer, by reacting the silylating agent with the hydroxyl groups.

Therefore, when the coating solution according to the third aspect is used in the treatment in the pre-stage of the modification of a substrate surface using a silylating agent, it is possible to perform the modification of the substrate surface successfully using a silylating agent, regardless of the type of substrate.

### EXAMPLES

Below, the present invention will be further specifically described by way of the Examples, but the present invention shall not be limited to the Examples below.

### Reference Example 1

After contacting the surface of the tungsten substrate with aqueous ammonia with a concentration of 1% by mass for 60 seconds and washing the surface of the substrate for 60 seconds with ion-exchange distilled water, a natural oxide film on the tungsten substrate surface was removed. Then, water adhering to the substrate surface was replaced with isopropanol. Then, the substrate was immersed in an n-decane solution of tetraisocyanate silane with a concentration of 5% by mass. By contacting the n-decane solution of tetraisocyanate silane with the substrate surface for 60 seconds, the hydrolysates of the tetraisocyanate silane were allowed to condensate with each other on the substrate surface to form a coating film on the substrate surface. Then, after replacing n-decane remaining on the substrate surface with isopropanol, the substrate was washed with ion-exchange distilled water for 60 seconds. After washing, nitrogen was blown over the substrate surface to dry the substrate surface.

Onto the substrate surface which was subjected to surface treatment according to the method described above, pure water droplets (1.8 μL) were placed drop-wise using Dropmaster 700 (manufactured by Kyowa Interface Science) and the contact angle was measured at 10 seconds after dropping. Further, the contact angle of water on the untreated substrate was also measured by the same method as the measurement method of the contact angle of water on the substrate surface subjected to surface treatment.

As a result, the contact angle of water on the untreated tungsten substrate was 39.3°, and the contact angle of water on the tungsten substrate after surface treatment with tetraisocyanate silane was 5.7°.

Based on the results of Reference Example 1, it is seen that the surface of the tungsten substrate was made hydrophilic by the treatment with tetraisocyanate silane.

### Examples 1 to 4

After contacting the surface of the tungsten substrate with aqueous ammonia with a concentration of 1% by mass for 60 seconds and washing the surface of the substrate for 60 seconds with ion-exchange distilled water, a natural oxide film on the tungsten substrate surface was removed. Then, water adhering to the substrate surface was replaced with isopropanol. Then, the substrate was immersed in an n-decane solution of tetraisocyanate silane with a concentration of 5% by mass. By contacting the n-decane solution of tetraisocyanate silane with the substrate surface for 60 seconds, the hydrolysates of the tetraisocyanate silane were allowed to condensate with each other on the substrate surface to form a coating film on the substrate surface. Then, the substrate treated with tetraisocyanate silane was immersed in an n-decane solution of a silylating agent containing the silylating agent disclosed in Table 1 in a concentration of 5% by mass, allowed to stand still for 60 seconds to perform the treatment with a silylating agent. After replacing n-decane remaining on the substrate surface treated with a silylating agent with isopropanol, the substrate was washed with ion-exchange distilled water for 60 seconds. After washing, nitrogen was blown over the substrate surface to dry the substrate surface.

Onto the substrate surface which was subjected to surface treatment according to the method described above, pure water droplets (1.8 μL) were placed dropwise using Dropmaster 700 (manufactured by Kyowa Interface Science) and the contact angle was measured at 10 seconds after dropping. The measurement results of contact angles of water are shown in Table 1.

### Comparative Examples 1 to 4

The substrate surface was treated in the same manner as in Examples 1 to 4, except that the treatment with the n-decane solution of tetraisocyanate silane with a concentration of 5% by mass was not performed. The silylating agents disclosed in Table 1 were used. The contact angle of water on the substrate surface which was subjected to the surface treatment was measured by the same method as in Examples 1 to 4. The measurement results of the contact angles of water are shown in Table 1.

### Examples 5 and 6

The substrate surface was treated in the same manner as in Examples 1 to 4, except that the material of substrate was changed to the materials disclosed in Table 1 and that treatment with aqueous ammonia was not performed. The silylating agents disclosed in Table 1 were used. The contact angles of water on the untreated substrate surface and on the substrate surface which was subjected to the surface treatment were measured by the same method as in Examples 1 to 4. The measurement results of the contact angles of water are shown in Table 1.

TABLE 1

| | | | Treatment | Contact Angle of Water | |
|---|---|---|---|---|---|
| | Material of | | with | Untreated | Treated |
| | Substrate | Silylating Agent | Si(NCO)₄ | State | State |
| Example 1 | W | 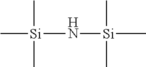 | Done | 39.3° | 93.8° |
| Example 2 | W | 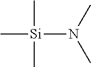 | Done | 39.3° | 100.8° |
| Example 3 | W | 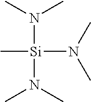 | Done | 39.3° | 104.2° |
| Example 4 | W | 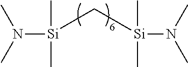 | Done | 39.3° | 85.4° |
| Example 5 | Cu | 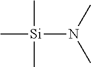 | Done | 52.4° | 102.8° |
| Example 6 | Au | 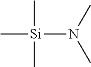 | Done | 86.0° | 105.6° |
| Comparative Example 1 | W | 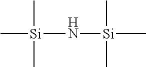 | Not Done | 39.3° | 23.4° |
| Comparative Example 2 | W | 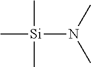 | Not Done | 39.3° | 27.4° |
| Comparative Example 3 | W | 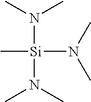 | Not Done | 39.3° | 68.2° |
| Comparative Example 4 | W | 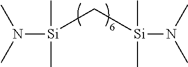 | Not Done | 39.3° | 42.0° |

According to Examples 1 to 6, it is seen that by treating a substrate surface with tetraisocyanate silane as the metal compound capable of forming a hydroxyl group by hydrolysis, and then performing a treatment with a silylating agent which is a water-repelling agent, even in substrates such as tungsten (W), copper (Cu) and gold (Au) which are difficult to be surface-modified by direct treatment using a silylating agent, the surfaces thereof have been made water-repellent successfully.

On the other hand, according to Comparative Examples 1 to 4, it is seen that when the tungsten substrate was treated directly with a silylating agent, without treating with a metal compound capable of forming a hydroxyl group by hydrolysis, the substrate surface was not made water-repellent successfully.

### Examples 7 to 9

Surface of a tungsten substrate was treated in the same manner as in Example 2, except that the n-decane solution of tetraisocyanate silane with a concentration of 5% by mass was replaced with the solutions of tetraisocyanate silane in the solvents disclosed in Table 2, with the concentration being the same, and that the n-decane solution of the silylating agent with a concentration of 5% by mass was replaced with the propylene glycol monomethyl ether acetate solution of the silylating agent with a concentration of 10% by mass. In Examples 7 to 9, the same silylating agent as in Example 2 was used. Incidentally, the contact angles of water on the tungsten substrate after treatment were measured in the same manner as in Example 2. The measurement results of the contact angles are shown in Table 2.

TABLE 2

| | | | Solvent | Contact Angle | |
|---|---|---|---|---|---|
| | Material | | in the | of Water | |
| | of | | Si(NCO)₄ | Untreated | Treated |
| | Substrate | Silylating Agent | Solution | State | State |
| Example 2 | W | 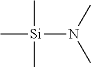 | n-Decane | 39.3° | 93.8° |
| Example 7 | W | 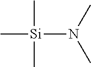 | p-Menthane | 39.3° | 115.8° |
| Example 8 | W | 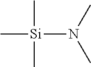 | n-Decene | 39.3° | 110.0° |
| Example 9 | W | 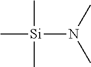 | p-Cymene | 39.3° | 109.4° |

According to Table 2, it is seen that tungsten substrate can be modified successfully by using various kinds of solvents as the solvent species to dissolve the metal compound capable of forming a hydroxyl group by hydrolysis.

### Example 10

A TiN substrate with a pattern was treated with an n-decane solution of tetraisocyanate with a concentration of 5% by mass and with an n-decane solution of a silylating agent containing the silylating agent in a concentration of 5% by mass, in the same manner as in Example 2. The pattern on the TiN substrate was 50 nm wide and 700 nm deep, and pitch was 100 nm and the aspect ratio was 14. The pattern on the TiN substrate was manufactured by an already-known method. After n-decane remaining on the substrate surface treated with the silylating agent was replaced with isopropanol, the substrate was rinsed with ion-exchanged distilled water for 60 seconds. After rinsing, the substrate surface was dried by spin drying. In the observation of the surface of dried TiN substrate with pattern under a scanning electron microscope (trade name: S-4700, manufactured by Hitachi High-Technologies), no pattern collapse was confirmed.

Based on Example 10, it is seen that by treating the surface of a substrate with pattern using a metal compound which is capable of forming a hydroxyl group by hydrolysis, followed by the treatment for providing water-repellency using a silylating agent, the substrate surface was made water-repellent successfully, thereby pattern collapse due to rinse treatment using pure water, etc. after the pattern formation was suppressed.

### Comparative Example 5

A TiN substrate with pattern was subjected to the treatment for providing water-repellency and was rinsed with ion-exchanged water in the same manner as in Example 10, except that, in the treatment using an n-decane solution of tetraisocyanate silane with a concentration of 5% by mass and in the treatment using an n-decane solution of a silylating agent containing the silylating agent in a concentration of 5% by mass, the formulations disclosed in Example 2 were changed to the formulations disclosed in Comparative Example 2. After rinsing, in observing the spin dried substrate under a scanning electron microscope (trade name: S-4700, manufactured by Hitachi High-Technologies), pattern collapse was confirmed.

Based on Comparative Example 5, it is seen that, in providing a surface of a substrate with pattern with water-repellency using a silylating agent, when the substrate surface was not treated with a metal compound capable of forming a hydroxyl group by hydrolysis prior to the water-repellency treatment, the substrate surface was not made water-repellent successfully, and therefore, pattern collapse is more likely to occur due to rinse treatment using pure water, etc. after the pattern formation.

1. A method for modifying a substrate surface comprising:
a process of treating a surface of a substrate with a metal compound which is capable of forming a hydroxyl group by hydrolysis and
a process of treating the surface of the substrate which has been treated with the metal compound, with a silylating agent.

2. The method for modifying a substrate surface according to claim 1, wherein the process of treating the surface of the substrate with the metal compound is a process of hydrophilization treatment of the substrate.

3. The method for modifying a substrate surface according to claim 1, wherein the process of treating the surface of the substrate which has been treated with the metal compound, with a silylating agent is a process of the treatment for providing the substrate with water-repellency.

4. A modifying film comprising a metal compound layer formed by applying a metal compound which is capable of forming a hydroxyl group by hydrolysis on the surface of a substrate, and a silane compound layer formed by applying a silylating agent on the surface of the metal compound layer.

5. The modifying film according to claim 4, wherein the silylating agent is a water-repelling agent.

6. A coating solution for the use in treating the surface of the substrate in the method for modifying a substrate surface according to claim 1, wherein the coating solution comprises a metal compound which is capable of forming a hydroxyl group by hydrolysis.
